(19) United States
(12) Patent Application Publication
(10) Pub. No.: US 2017/0199043 A1
(43) Pub. Date: Jul. 13, 2017

(54) NAVIGATION METHOD

(71) Applicant: MITAC INTERNATIONAL CORP., Taoyuan City (TW)

(72) Inventor: Wen-Shan CHEN, Taoyuan City (TW)

(21) Appl. No.: 15/399,636

(22) Filed: Jan. 5, 2017

(30) Foreign Application Priority Data
Jan. 7, 2016 (TW) 105100338

(51) Int. Cl. G01C 21/32; G01C 21/36

(52) U.S. Cl. CPC G01C 21/32; G01C 21/3629; G01C 21/3655; G01S 19/40

(57) ABSTRACT

A navigation method is to be implemented by a navigation device, and includes the steps of: planning a route which passes through a plurality of administrative divisions according to a destination inputted thereto; designating at least one of the plurality of administrative divisions as a navigation division based on a user input or on a record; determining whether a current position of the navigation device is in the navigation division; and providing navigation guidance via the navigation device when it is determined that the current position of the navigation device is in the navigation division.

### CROSS-REFERENCE TO RELATED APPLICATION

This application claims priority of Taiwanese Patent Application No. 105100338, filed on Jan. 7, 2016.

### FIELD

The disclosure relates to a navigation method, and more particularly to a navigation method capable of providing navigation guidance depending on different needs.

### BACKGROUND

A navigation system is configured to plan a route starting from a current position to an inputted destination, and to provide navigation guidance based on the route thus planned by at least one of a navigation map, an audible instruction or a visible instruction.

However, when the route thus planned has portions that are familiar to a driver, a conventional navigation system lacks flexibility to omit the navigation guidance for those portions which are not needed by the driver. The lack in flexibility may cause inefficient utilization of computational resources and unnecessary interruption which may distract the driver.

### SUMMARY

Therefore, an object of the disclosure is to provide a navigation method that can alleviate at least one of the drawbacks of the prior art.

According to one aspect of the disclosure, the navigation method is to be implemented by a navigation device. The navigation method includes the steps of:

a) planning, by the navigation device according to a destination inputted thereto, a route which passes through a plurality of administrative divisions;

b) designating, by the navigation device based on a user input, at least one of the plurality of administrative divisions as a navigation division; and

c) determining by the navigation device whether a current position of the navigation device is in the navigation division, and providing navigation guidance via the navigation device when it is determined that the current position of the navigation device is in the navigation division.

According to the other aspect of the disclosure, the navigation method includes the steps of:

A) planning, by the navigation device according to the destination inputted thereto, the route which passes through a plurality of the administrative divisions;

B) designating, by the navigation device based on a record, at least one of the plurality of administrative divisions as the navigation division; and

C) determining by the navigation device whether the current position of the navigation device is in the navigation division, and providing the navigation guidance via the navigation device when it is determined that the current position of the navigation device is in the navigation division.

### BRIEF DESCRIPTION OF THE DRAWINGS

Other features and advantages of the disclosure will become apparent in the following detailed description of the embodiment with reference to the accompanying drawings, of which:

FIG. 1 is a flow chart illustrating an embodiment of a navigation method according to the disclosure;

FIG. 2 is a block diagram illustrating an embodiment of a navigation device that implements the navigation method of this disclosure;

FIG. 3 is a schematic diagram illustrating an example of a route planned;

FIG. 4 is a schematic diagram illustrating an example of a navigation map that shows detailed information in the navigation method;

FIG. 5 is a flow chart illustrating an embodiment of one feature of the navigation method according to the disclosure;

FIG. 6 is a flow chart illustrating an embodiment of another feature of the navigation method according to the disclosure; and

FIG. 7 is a flow chart illustrating an embodiment of still another feature of the navigation method according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

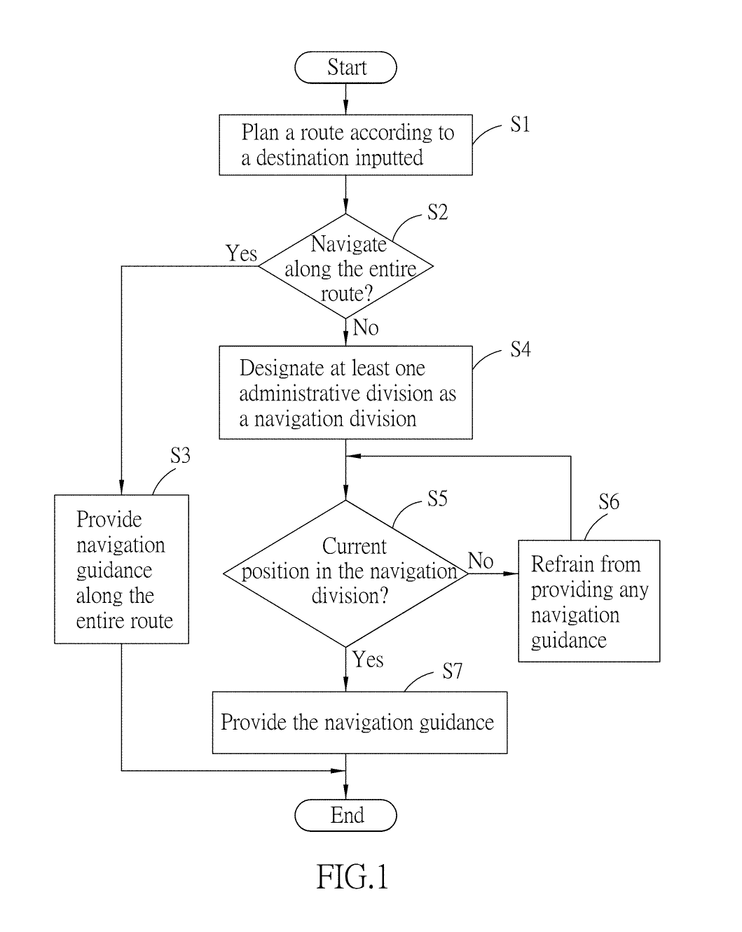

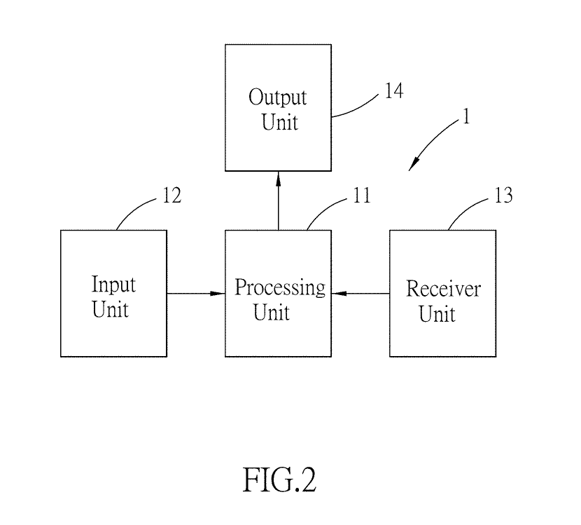

Referring to FIG. 1, a flow chart of a first embodiment of a navigation method according to the disclosure is illustrated. The navigation method is to be implemented by a navigation device 1 (see FIG. 2). As shown in FIG. 2, the navigation device 1 includes a processing unit 11, and an input unit 12, a receiver unit 13 and an output unit 14 which are coupled electrically to the processing unit 11. The input unit 12 is configured to be operated by a user to input a destination and to interact with the navigation device 1. It should be noted that in this embodiment, the navigation device 1 by default sets a current position of the navigation device 1 as a start position for navigation. However, implementation of setting of the start position is not limited thereto. The receiver unit 13 is implemented by a GPS (global positioning system) receiver so as to receive GPS positioning information from a GPS satellite for determining a position of the navigation device 1 (i.e., the current position) which is outputted to the processing unit 11. The output unit 14 is implemented by a display and/or a speaker, and is configured to provide navigation guidance which includes at least one of a navigation map, an audible instruction or a visible instruction which may be associated with, but are not limited to, the route thus planned and the current position of the navigation device 1.

The method has the following steps S1-S7.

In step S1, the processing unit 11 of the navigation device 1 plans a route which passes through a plurality of administrative divisions according to a destination inputted to the navigation device 1. For example, a user who wishes to drive under assistance of the navigation device 1 from the current position, e.g., Boston, to the destination, e.g., New York City (NYC), may input via the input unit 12 the destination to the navigation device 1. The processing unit 11 plans the route according to the current position and the destination inputted by the user, and the output unit 14 displays the route thus planned thereon as a reference for the user. In addition, the navigation device 1 prompts the user to decide whether to adopt the route thus planned for subsequent navigation process. It is worth to note that in other embodiments, the navigation device 1 may directly prompt the user to decide whether to proceed to the subsequent navigation process without displaying the route thus planned on the output unit 14.

In step S2, the navigation device 1 inquires whether to provide the navigation guidance along the entire route. When it is determined by the navigation device 1 to provide the navigation guidance along the entire route according to an affirmative response from the user, the navigation device 1 provides the navigation guidance along the entire route as shown in step S3. In contrast, when it is determined not to provide the navigation guidance along the entire route according to a negative response from the user, the navigation device 1 does not provide the navigation guidance along the entire route, and the flow proceeds to step S4 where the processing unit 11 designates at least one of the plurality of administrative divisions as a navigation division.

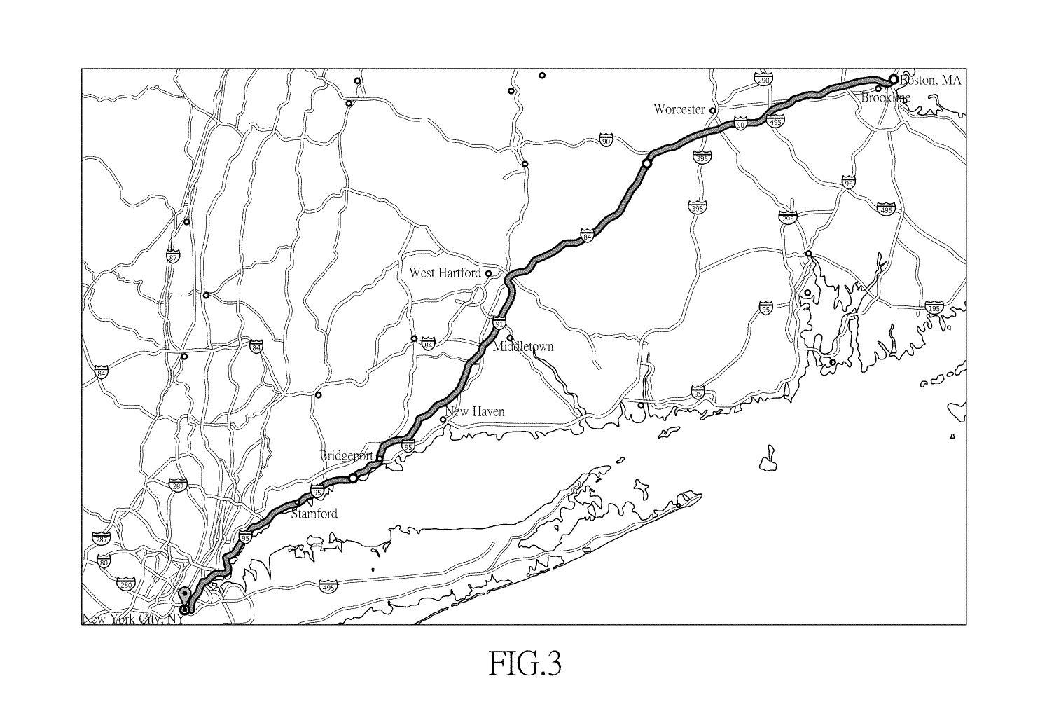

In this embodiment, the navigation device 1 designates at least one of the plurality of administrative divisions as the navigation division based on a user input. Specifically speaking, the processing unit 11 receives via the input unit 12 a request for designating navigation division. In response to the request, the processing unit 11 controls the output unit 14 to display the administrative divisions passed by the route thus planned. The processing unit 11 receives via the input unit 12 the user input that indicates said at least one of the administrative divisions to be designated, and designates said at least one of the administrative divisions to serve as the navigation division based on the user input. The administrative division may be a state or an equivalent thereof, a county or an equivalent thereof, a town or an equivalent thereof, a municipality or an equivalent thereof, an administrative division in the United States that does not belong to the aforementioned class, or a combination of at least two of the above. For example, the user is going to drive from Boston to NYC, and the navigation device 1 has planned for him/her the route, which includes interstate highways I-90, I-84, I-91 and I-95 as illustrated in FIG. 3. Also, the navigation device 1 displays thereon the route and the administrative divisions passed by the route (such as Middletown, New Haven and Bridgeport). However, for a user who is familiar with a portion of the route from Boston through the highways I-90 and I-84, navigation guidance on merely the remaining portion of the route, with which he/she is not familiar, may be desirable. Therefore, the administrative divisions passed by the portion of the route from Boston to the highway I-84 are neglected, and the administrative divisions passed by the remaining portion of the route are designated to serve as the navigation division. After the navigation division has been set up, the flow proceeds to step S5.

In step S5, the processing unit 11 of the navigation device 1 keeps determining whether the current position of the navigation device 1 received from the receiver unit 13 is in the navigation division, and provides navigation guidance via the output unit 14 as shown in step S7 when it is determined that the current position of the navigation device 1 is in the navigation division. When it is determined by the processing unit 11 that the current position of the navigation device 1 is not in the navigation division, the processing unit 11 refrains from providing any navigation guidance, such as the navigation map, the visible instruction and/or the audible instruction, via the output unit 14 as shown in step S6. In some embodiments, the processing unit 11 may provide via the output unit 14 coarse navigating information without turn-by-turn navigation when it is determined by the processing unit 11 that the current position of the navigation device 1 is not in the navigation division. The coarse navigation information may include merely towns, points of interest (POIs) and/or service areas, the current position of the navigation device 1, the route and the administrative divisions passed by the route which are presented on a map. As a result, though the receiver unit 13 keeps receiving the GPS positioning information and determining the current position of the navigation device 1 so as to output the same to the processing unit 11, the processing unit 11 does not have to update accordingly the navigation guidance in real time. In consequence, computational resources are efficiently utilized, and interruption, which is caused by unnecessary navigation guidance provided to a driver, is alleviated.

Moreover, in step S5, when the processing unit 11 determines that the current position of the navigation device 1 is in the navigation division, step S7 is performed so that the processing unit 11 controls the output unit 14 to provide the navigation guidance by outputting the navigation map, the audible instruction and/or the visible instruction. At this moment, the navigation map may show a detailed map that is associated with an area within a predetermined range, such as 0.5 miles or 1 mile, around the current position of the navigation device 1 and that has clear instructions presented thereon, so as to assist the user in driving in various kinds of areas and arriving successfully at the destination.

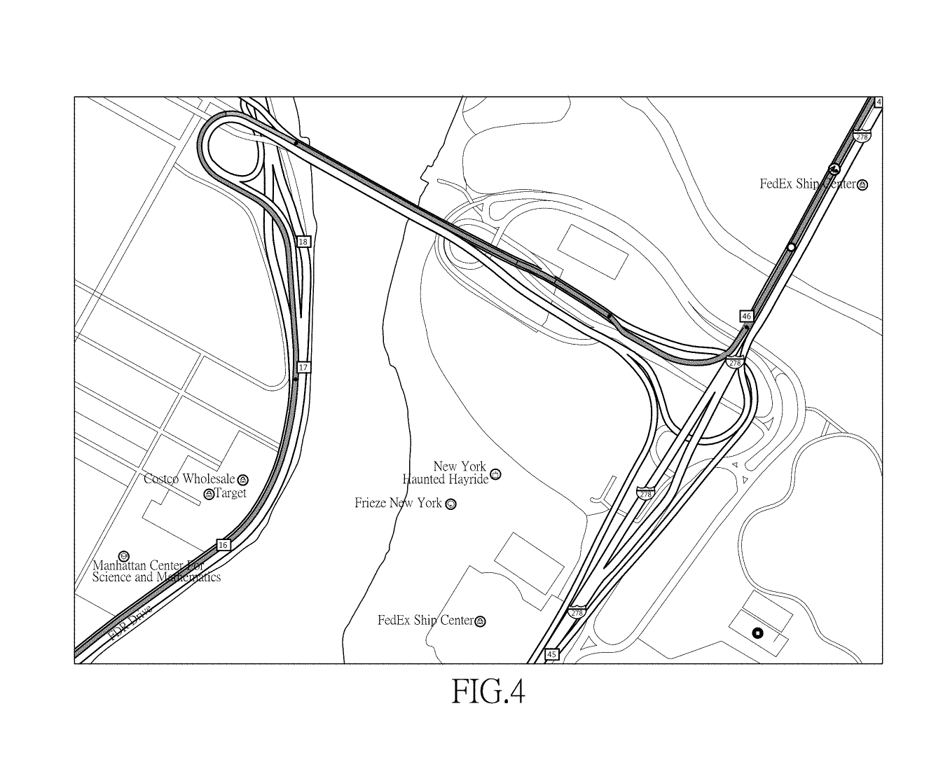

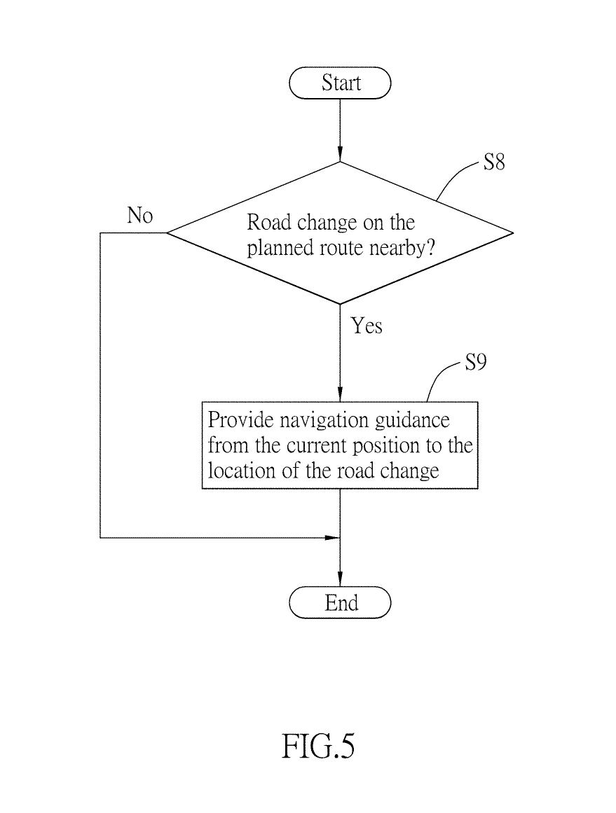

Furthermore, referring to FIG. 5, in a condition that the route thus planned includes a road change, which may be a change from one road to a different road in the route thus planned, e.g., changing between two highways I-91 and I-95, or may be a change between different types of roads in the route thus planned, e.g., changing between the highway I-278 and the FDR drive, the processing unit 11 keeps performing a first procedure. In the first procedure, the processing unit 11 determines whether the current position of the navigation device 1 is within a predetermined distance from a location of the road change in the route as shown in step S8. When it is determined by the processing unit 11 that the current position of the navigation device 1 is within the predetermined distance from the location of the road change in the route, as shown in step S9, the navigation device 1 provides the navigation guidance from the current position of the navigation device 1 to the location of the road change in the route, such as the navigation map that shows detailed information indicating how to drive from the current position to the location of the road change. For example, as shown in FIG. 4, the processing unit 11 controls the output unit 14 to provide the navigation map that shows detailed information indicating how to change way from the highway I-278 to the FDR drive when it is determined by the processing unit 11 that the exit 46 (shown as a mark 46 in FIG. 4) of the highway I-278 is within 1 mile from the current position of the navigation device 1.

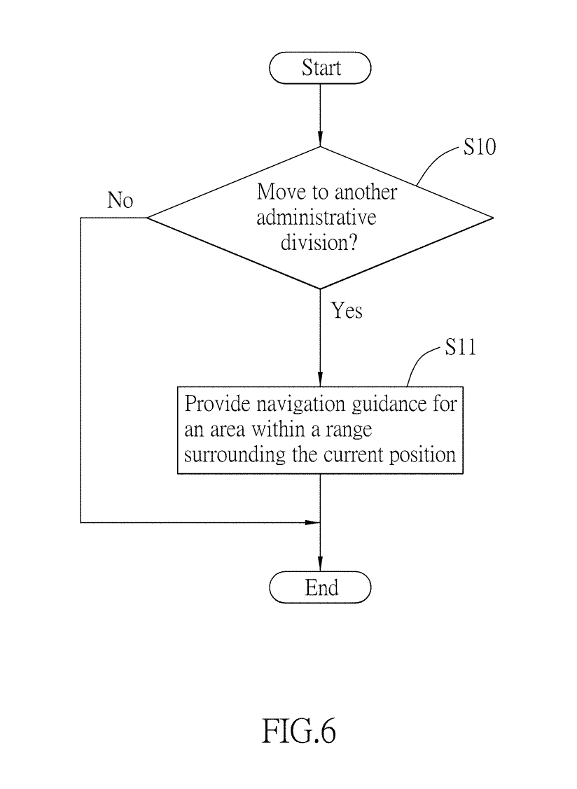

Additionally, as illustrated in FIG. 6, during the navigation process, the processing unit 11 further keeps performing a second procedure. In the second procedure, the processing unit 11 determines whether the navigation device 1 is to be moved from a current administrative division into another administrative division as shown in step S10. When it is determined by the processing unit 11 that the navigation device 1 is to be moved from the current administrative division into another administrative division, as shown in step S11, the navigation device 1 provides the navigation guidance for an area within a predetermined range surrounding the current position of the navigation device 1, such as a navigation map that shows detailed information associated with a 0.5-mile or 1-mile surrounding area.

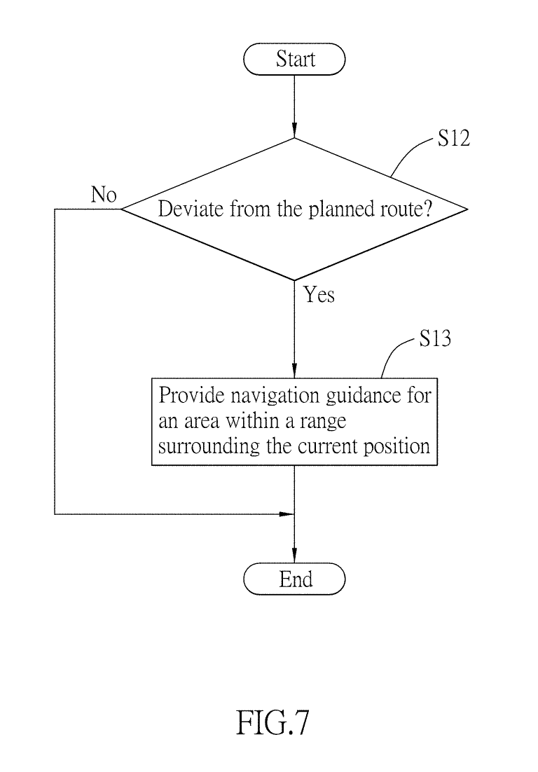

In addition, as illustrated in FIG. 7, the processing unit 11 keeps performing a third procedure. In the second procedure, the processing unit 11 receives the current position from the receiver unit 13 during the navigation process, and determines whether the current position of the navigation device 1 has deviated from the route thus planned as shown in step S12. When it is determined by the processing unit 11 that the current position of the navigation device 1 has deviated from the route thus planned, which may occur when the user takes the wrong exit on the highway, as shown in step S13, the processing unit 11 controls the output unit 14 to provide the navigation guidance for an area within a predetermined range surrounding the current position of the navigation device 1, such as a navigation map that shows detailed information associated with a 0.5-mile or 1-mile surrounding area for assisting the user in returning to the route thus planned.

Referring once again to FIG. 1, a second embodiment of the navigation method is similar to the first embodiment of the navigation method, but is different from the first embodiment in that in step S4, the processing unit 11 designates at least one of the plurality of administrative divisions as a navigation division based on a record. Specifically speaking, the processing unit 11 retrieves the record associated with routes planned previously by the processing unit 11 or routes which have actually been taken (travelled) by the user previously, determines frequency of occurrence of individual administrative division passed by the routes planned previously or by the routes which have actually been taken by the user previously, and designates the administrative division that is determined to have a low frequency of occurrence (e.g., a lowest frequency of occurrence) to serve as the navigation division. Optionally, an inquiry may be generated for user's confirmation as to whether the administrative division designated as the navigation division is desired by the user.

In summary, the navigation method is implemented by the navigation device 1, and includes the steps of planning a route according to the destination inputted, designating at least one of a plurality of administrative divisions passed by the route thus planned as a navigation division, determining whether a current position of the navigation device 1 is in the navigation division, and providing navigation guidance when it is determined that the current position of the navigation device 1 is in the navigation division. Moreover, the navigation method further includes a step of providing the navigation guidance when it is determined that the navigation device 1 is to be moved from a current administrative division into another administrative division, that the current position of the navigation device 1 is within a predetermined distance from the location of a road change in the route, or that the current position of the navigation device 1 has deviated from the route thus planned. Therefore, by the navigation method of this disclosure, the computational resources are efficiently used, the unnecessary interruption is alleviated, and the user is capable of being assisted as needed to drive to the destination.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiments but is intended to cover various arrangements included within the spirit and scope of the broadest interpretation so as to encompass all such modifications and equivalent arrangements.

What is claimed is:

1. A navigation method to be implemented by a navigation device, the method comprising steps of:
a) planning, by the navigation device according to a destination inputted thereto, a route which passes through a plurality of administrative divisions;
b) designating, by the navigation device based on a user input, at least one of the plurality of administrative divisions as a navigation division; and
c) determining by the navigation device whether a current position of the navigation device is in the navigation division, and providing navigation guidance via the navigation device when it is determined that the current position of the navigation device is in the navigation division.

2. The navigation method of claim 1, subsequent to step a), further comprising a step of:
in a condition that the route thus planned includes a road change, when it is determined by the navigation device that the current position of the navigation device is within a predetermined distance from a location of the road change in the route, providing by the navigation device the navigation guidance from the current position of the navigation device to the location of the road change in the route.

3. The navigation method of claim 2, wherein the road change includes a change between different roads in the route thus planned.

4. The navigation method of claim 2, wherein the road change includes a change between different types of roads in the route thus planned.

5. The navigation method of claim 1, wherein step b) includes sub-steps of:
b1) receiving, by the navigation device, a request for designating navigation division;
b2) displaying, by the navigation device in response to the request, the administrative divisions passed by the route thus planned;
b3) receiving, by the navigation device, the user input that indicates said at least one of the administrative divisions to be designated; and
b4) designating, by the navigation device based on the user input, said at least one of the administrative divisions to serve as the navigation division.

6. The navigation method of claim 1, wherein step c) further includes:
refraining from providing any navigation guidance via the navigation device when it is determined by the navigation device that the current position of the navigation device is not in the navigation division.

7. The navigation method of claim 1, wherein step c) further includes:
providing coarse navigating information without turn-by-turn navigation when it is determined by the navigation device that the current position of the navigation device is not in the navigation division.

8. The navigation method of claim 1, wherein in step c), navigation guidance includes at least one of a navigation map, an audible instruction or a visible instruction.

9. The navigation method of claim 1, subsequent to step a), further comprising a step of:
providing by the navigation device the navigation guidance for an area within a predetermined range surrounding the current position of the navigation device when it is determined by the navigation device that the navigation device is to be moved from a current administrative division into another administrative division.

10. The navigation method of claim 1, subsequent to step a), further comprising a step of:
when it is determined by the navigation device that the current position of the navigation device has deviated from the route thus planned, providing by the navigation device the navigation guidance for an area within a predetermined range surrounding the current position of the navigation device.

11. A navigation method to be implemented by a navigation device, the method comprising steps of:
A) planning, by the navigation device according to a destination inputted thereto, a route which passes through a plurality of administrative divisions;
B) designating, by the navigation device based on a record, at least one of the plurality of administrative divisions as a navigation division; and
C) determining by the navigation device whether a current position of the navigation device is in the navigation division, and providing navigation guidance via the navigation device when it is determined that the current position of the navigation device is in the navigation division.

12. The navigation method of claim 11, subsequent to step A), further comprising a step of:
in a condition that the route thus planned includes a road change, when it is determined by the navigation device that the current position of the navigation device is within a predetermined distance from a location of the road change in the route, providing by the navigation device the navigation guidance from the current position of the navigation device to the location of the road change in the route.

13. The navigation method of claim 12, wherein the road change includes a change between different roads in the route thus planned.

14. The navigation method of claim 12, wherein the road change includes a change between different types of roads in the route thus planned.

15. The navigation method of claim 11, wherein step B) includes sub-steps of:
B1) retrieving, by the navigation device, a record associated with routes planned previously by the navigation device or routes which have actually been taken previously;
B2) determining, by the navigation device, frequency of occurrence of each administrative division passed by the routes planned previously or by the routes which have actually been taken previously; and
B3) designating, by the navigation device, the administrative division that is determined to have a low frequency of occurrence to serve as the navigation division.

16. The navigation method of claim 11, wherein step C) further includes:
refraining from providing any navigation guidance via the navigation device when it is determined by the navigation device that the current position of the navigation device is not in the navigation division.

17. The navigation method of claim 11, wherein step C) further includes:
providing coarse navigating information without turn-by-turn navigation when it is determined by the navigation device that the current position of the navigation device is not in the navigation division.

18. The navigation method of claim 11, wherein in step C), navigation guidance includes at least one of a navigation map, an audible instruction or a visible instruction.

19. The navigation method of claim 11, subsequent to step A), further comprising a step of:
providing by the navigation device the navigation guidance for an area within a predetermined range surrounding the current position of the navigation device when it is determined by the navigation device that the navigation device is to be moved from a current administrative division into another administrative division.

20. The navigation method of claim 11, subsequent to step A), further comprising a step of:
when it is determined by the navigation device that the current position of the navigation device has deviated from the route thus planned, providing by the navigation device the navigation guidance for an area within a predetermined range surrounding the current position of the navigation device.
